(19) United States
(12) Patent Application Publication
(10) Pub. No.: US 2026/0233823 A1
(43) Pub. Date: Aug. 13, 2026

(54) MOORING SYSTEM FOR FLOATING OFFSHORE WIND POWER PLATFORM, MONITORING SYSTEM AND MONITORING METHOD THEREOF

(71) Applicant: Shanghai Investigation, Design & Research Institute Co., Ltd., Shanghai (CN)

(72) Inventors: Xinyi WU, Shanghai (CN); Yu LIN, Shanghai (CN); Yan NIE, Shanghai (CN); Ke FAN, Shanghai (CN); Juan JIANG, Shanghai (CN); Haifeng CHENG, Shanghai (CN); Yifeng LIN, Shanghai (CN)

(73) Assignee: Shanghai Investigation, Design & Research Institute Co., Ltd., Shanghai (CN)

(21) Appl. No.: 18/842,813

(22) PCT Filed: May 31, 2024
(86) PCT No.: PCT/CN2024/096749

§ 371 Date: Apr. 17, 2026

(30) Foreign Application Priority Data
Jul. 31, 2023 (CN) 202310951328.0

(51) Int. Cl. B63H 25/42; B63B 35/44

(52) U.S. Cl. CPC B63H 25/42; B63B 35/44; B63B 2035/446

(57) ABSTRACT

A mooring system and monitoring system for a floating offshore wind turbine platform, including a static mooring system and a dynamic mooring system. The static mooring system includes three mooring cable bundles, with the center of the pillars (1) and the center of the mooring cable bundles being coincided. The dynamic mooring system includes power units, thruster units (4), and control units. Below each of the pillars of the wind turbine platform, a set of thruster units (4) is installed, with each set including 1 to 4 thruster units (4). The platform monitoring system implements real-time monitoring of the platform, obtaining the motion state and mooring tension of the platform. Based on the real-time motion state, the system calculates the required power for the thruster units (4) to meet the tilt and mooring tension requirements of the platform, the power is then executed by the thruster units (4).

### CROSS REFERENCE TO RELATED APPLICATION

This is a Sect. 371 National Stage of PCT International Application No. PCT/CN2024/096749, filed on May 31, 2024, which claims priority of a Chinese Patent Application No. 202310951328.0 filed with CNIPA on Jul. 31, 2023, both of which are hereby incorporated by reference in their entireties.

### FIELD OF TECHNOLOGY

The present disclosure relates to the technical field of mooring systems for offshore wind turbine platforms, in particular, to a mooring system for a floating offshore wind turbine platform, a monitoring system, and a monitoring method.

### BACKGROUND

Traditional single-point mooring systems include tower soft arms, catenary buoys, single-anchor leg buoys, internal turret types, and external turret types. Conventional multi-point mooring systems generally adopt arrangements such as 3×3, 3×2, 6×1, and 8×1. Due to the harsh conditions of the marine environment, offshore floating wind turbines are often subjected to significant wind, waves, and current loads. Existing mooring systems are unable to meet the demands for resisting large loads; as wind and wave effects increase, the loads on the mooring system also rise. However, the resisting structures are static and cannot enhance the safety and reliability of the mooring system as the loads increase. Additionally, static load monitoring for the mooring system is ineffective; under critical load conditions, there is no way to effectively reduce or manage the load.

In the related technology, application No. CN2023103264852 presents a floating offshore wind power foundation and its installation method, proposing a floating foundation that lowers the center of gravity of the floating foundation through a suspended ballast chamber to increase the damping of oscillatory movements of the floating foundation, thereby reducing the overall size. However, this approach faces the challenge of severe load variations and lacks countermeasures, still relying on a static method to resist loads.

Application No. CN2023103161930 introduces a tension device and monitoring method for mooring cables of marine floating structures, addressing the issues of high precision requirements and costly operations during the installation and maintenance of existing permanent fixed mooring systems and aging platform mooring systems. This method primarily relies on comprehensive monitoring of the tension and positional changes of the mooring anchor chain to assess load conditions. By measuring the tension of the mooring anchor chain through sensors, it focuses on the tensile load-bearing capacity of the floating object, predicting overload risks and potential rupture or deformation. While this method assesses safety by observing and predicting risks, it lacks countermeasures for severe load variations and only measures imminent loads, failing to address future larger-scale load changes that may occur over an hour or half a day, and struggles to mitigate the risks associated with impending dramatic load changes.

Application No. CN2023105274986 proposes a real-time monitoring system and method for mooring forces of deepwater internal turret single-point systems. This system can achieve accurate real-time monitoring of deepwater internal turret mooring forces through model establishment and verification; however, it is suitable for floating production, storage, and offloading vessels, not for floating offshore wind power platforms. Furthermore, it focuses on deepwater internal turret single-point mooring systems, which also face severe load variations and lack countermeasures, continuing to rely on static load resistance.

Therefore, there is a need for a mooring system for a floating offshore wind power platform, a monitoring system, and a monitoring method to overcome the above-mentioned issues.

### SUMMARY

The present application provides a mooring system for a floating offshore wind power platform, a platform monitoring system for a mooring system of a floating offshore wind turbine platform, and a platform monitoring method for a mooring system of a floating offshore wind turbine platform.

The present disclosure addresses one of the issues identified in the background technology by combining a multi-point mooring system with a dynamic positioning system. A platform monitoring system will conduct real-time monitoring of the platform's motion status and the tension of the mooring system. When the motion of the platform reaches a certain critical point, the dynamic positioning system will be activated, and the thruster unit equipment located beneath the platform will be engaged. By reading real-time data on the current motion status of the platform and the tension in the mooring system, the required thrust load will be calculated to confine the platform's movement within a specified range while satisfying the mooring tension requirements. Ultimately, the power needed for the thruster units will be calculated and communicated to the three sets of thruster units located beneath the platform for real-time operational functionality.

The mooring system for the floating offshore wind turbine platform includes a static mooring system and a dynamic mooring system.

The static mooring system includes three mooring cable bundles, each of the mooring cable bundles is connected to one of pillars of the wind turbine platform; each of the mooring cable bundles includes 1 to 3 mooring cables, and each of the mooring cable bundles is configured in a catenary shape; the center of the pillars coincides with centers of each of the mooring cable bundles are aligned.

The dynamic mooring system includes power units, thruster units, and control units.

Each of the power units includes an engine, a generator set, a distribution panel, and cables.

Each of the thruster units includes a supporting drive shaft, propellers, a rotating motor, and a universal joint.

Each of the control units includes a positioning system, sensors, a computer system, a control interface, a control strategy module, and a power management module.

A set of thruster units is installed beneath each of the pillars of the wind turbine platform, with each set of the thruster units including 1 to 4 thruster units.

Preferably, pillars of the wind turbine platform are arranged in a circular array, with the center of the array coinciding with the center of the wind turbine platform or the center of arrangement of all pillars.

Preferably, the mooring cable bundles are arranged in a circular array, with the center of the array coinciding with the center of the wind turbine platform or the center of arrangement of all pillars.

Preferably, the included angle between each two adjacent mooring cable bundles is 120 degrees.

Preferably, each set of the thruster units may include a single thruster unit, and the thruster unit is installed directly beneath one of the pillars.

Preferably, each set of the thruster units may also include two thruster units, and the two thruster units are symmetrically installed on two sides beneath one of the pillars.

Preferably, each set of the thruster units may also include three thruster units, the three thruster units are uniformly distributed beneath one the pillars in an equilateral triangle configuration, and each of the three thruster units maintains equal distance from the central axis of one of the pillars.

Preferably, each set of the thruster units may also include four thruster units, the four thruster units are installed beneath four corners below one of the pillars, and each of the four thruster units maintains equal distance from the central axis of the pillar.

Preferably, each set of the thruster units has degrees of freedom for rotation of 360 degrees in a horizontal direction and 90 degrees in a vertical direction.

The platform monitoring system for the mooring system of the floating offshore wind turbine platform includes a positioning monitoring system and an environmental measurement system.

The positioning monitoring system includes a satellite positioning system, a laser positioning system, and an underwater ultra-short baseline acoustic positioning device. The positioning system calculates the actual direction and position of the wind turbine platform by measuring the deviations in direction and distance between the wind turbine platform and reference points.

The environmental measurement system includes a platform motion measurement system, an anemometer for wind speed and direction, an electrical compass, a mooring system tension monitoring system, and an offshore hydrometeorological observation platform. The environmental measurement system can measure motion parameters in six degrees of freedom for the wind turbine platform, the tension values of the mooring system, wind speed and direction parameters at the turbine, and wave and current parameters in the environment in which the wind turbine platform is located, thereby estimating the external force loads acting on the wind turbine platform.

The platform monitoring method for the mooring system of the floating offshore wind turbine platform involves the platform monitoring system conducting real-time monitoring of the wind turbine platform to obtain motion status and mooring tension of the wind turbine platform. Based on real-time motion status concerning displacement tilt and mooring tension requirements of the wind turbine platform, the required power for the thruster units is calculated and executed by the thruster units.

The platform monitoring method includes Step 1 and Step 2. Step 1, reading external environmental conditions-wind, waves, and currents-through the environmental measurement system to calculate the environmental external loads acting on the wind turbine platform. Reading the real-time tension of the mooring system through the positioning monitoring system. Reading the relative position and direction of the wind turbine platform via a wind turbine platform positioning monitoring system. Reading the acceleration and velocity of motion in six degrees of freedom of the wind turbine platform through the wind turbine platform motion monitoring system.

Step 2, analyzing data obtained from step 1 and importing the analyzed data into a computer system; calculating required acting force to maintain the wind turbine platform's displacement and direction based on design positioning requirements of the wind turbine platform and inherent characteristics of the wind turbine platform, where the inherent characteristics comprises weight, center, center of buoyancy, static stiffness, and damping parameters, where the acting force represents a resultant force that entire thrust system should generate.

Preferably, a wind load F^{wd}(x) on the wind turbine is assessed using the blade element momentum theory, with a calculation expressed as follows:

$${F}^{w d} ( x ) = 0 \text{.5} ρ {C}_{T} {A}_{rotor} {U}_{10 min}^{2}$$

The equation includes the following variables: ρ represents air density; C_{T} represents a thrust coefficient; Aᵣₒₜₒᵣ represents a swept area of the wind rotor; Aᵣₒₜₒᵣ=πR², R represents a radius of the wind rotor; and U_{10 min} represents a 10-minute average wind speed at the hub height.

A wave load

$${\overline{{F}_{i}}}^{wa}$$

(x) on a foundation of the wind turbine platform can be calculated using the measured wave spectrum S(ω), with a calculation expressed as follows:

$${\overline{{F}_{i}}}^{wa} = 2 {\int }_{0}^{∞} {C}_{i}^{w a} ( ω , β ) S ( ω ) d ω$$

where

$${\overline{{F}_{i}}}^{wa}$$

represents an average wave force numerator; β represents a wave direction relative to a longitudinal axis of the wind turbine platform;

$${C}_{i}^{w a} ( ω , β )$$

represents a wave drift coefficient relative to the wave direction; and S(ω) represents a wave spectrum.

An average wind load

$${\overline{{F}_{i}}}^{wi}$$

on the foundation of the wind turbine platform can be calculated using a measured wind speed, with a calculation expressed as follows:

$${\overline{{F}_{i}}}^{wi} = {C}_{i}^{W} i ( β ) {\overline{V}}^{2}$$

where

$${C}_{i}^{w i}$$

represents a wind force coefficient for each direction of the foundation of the wind turbine platform; β represents a wind direction relative to the wind turbine platform's longitudinal axis; and V̅ represents an average wind speed.

A current load Fᵢ^{cu} on the foundation of the wind turbine platform can be calculated using a measured flow velocity, expressed as follows:

$${F}_{i}^{c u} = {C}_{L , i}^{c u} ( β ) {V}_{r e l} + {C}_{Q , i}^{c u} ( β ) {V}_{r e l}^{2}$$

$${V}_{r e l} = \sqrt{{( {v}_{1}^{c u} - {v}_{1} )}^{2} + {( {v}_{2}^{c u} - {v}_{2} )}^{2}}$$

where,

$${C}_{L , i}^{c u}$$

represents a primary now force coefficient for each direction of the foundation of the wind turbine platform;

$${C}_{Q , i}^{c u}$$

represents a secondary flow force coefficient for each direction of the foundation of the wind turbine platform;

$${v}_{1}^{cu} , {v}_{2}^{cu}$$

represent horizontal components of the flow velocity; and v₁, v₂ represents the longitudinal and lateral velocities of the wind turbine platform.

A static equilibrium calculation for the wind turbine platform can be expressed as follows:

$${F}^{mo} ( x ) + {F}^{hs} ( x ) + {F}^{th} ( x ) + {F}^{cu} ( x ) + {F}^{wi} ( x ) + {F}^{wd} ( x ) + {F}^{wa} ( x ) = 0$$

where F^{mo}(x) represents a mooring tension; F^{hs}(x) is a static water force on the foundation of the wind turbine platform; F^{th}(x) represents a total force of thruster units; F^{cu}(x) represents a current load on the foundation of the wind turbine platform; F^{wi}(x) represents a wind load on the foundation of the wind turbine platform; F^{wd}(x) represents a wind load on the wind turbine; and F^{wa}(x) wave represents a wave load on the foundation of the wind turbine platform.

Preferably, the method includes a control method for the thruster units, designed to manage at least two sets of thruster units.

The thrust can be controlled by real-time monitoring of the wind turbine platform's motion variables, with the calculation expressed as follows:

$${F}^{th} ( x ) = - {G}_{P} Δ x - {G}_{V} v + {F}^{0}$$

where G_{P} represents a displacement coefficient matrix; G_{V} represents a velocity coefficient matrix; Δx represents a displacement matrix of the wind turbine platform; v represents a velocity matrix of the wind turbine platform; and F⁰ represents a thrust constant.

The resultant thrust force is composed of the thrust generated by each of the thruster units, with a calculation expressed as follows:

$${F}^{th} ( x ) = AT$$

where A is the thruster unit matrix, comprising the positions and orientations of each thruster unit, expressed as follows:

$$A = ( \begin{matrix}{cosα}_{1} {cosβ}_{1} & {cosα}_{2} {cosβ}_{2} & … \\ {sinα}_{1} {cosβ}_{1} & {sinα}_{2} {cosβ}_{2} & … \\ {sinβ}_{1} & {sinβ}_{2} & … \\ \begin{matrix}{z}_{1} {sinα}_{1} {cosβ}_{1} + \\ {y}_{1} {sinβ}_{1}\end{matrix} & \begin{matrix}{z}_{2} {sinα}_{2} {cosβ}_{2} + \\ {y}_{2} {sinβ}_{2} {y}_{2} {sinβ}_{2}\end{matrix} & … \\ \begin{matrix}{z}_{1} {cosα}_{1} {cosβ}_{1} + \\ {y}_{1} {sinβ}_{1}\end{matrix} & \begin{matrix}{z}_{2} {cosα}_{2} {cosβ}_{2} + \\ {y}_{2} {sinβ}_{2}\end{matrix} & … \\ \begin{matrix}{y}_{1} {cosα}_{1} {cosβ}_{1} + \\ {x}_{1} {sinα}_{1} {cosβ}_{1}\end{matrix} & \begin{matrix}{y}_{2} {cosα}_{1} {cosβ}_{2} + \\ {x}_{2} {sinα}_{2} {cosβ}_{2}\end{matrix} & …\end{matrix} \begin{matrix}{cosα}_{N} {cosβ}_{N} \\ {sinα}_{N} {cosβ}_{N} \\ {sinβ}_{N} \\ \begin{matrix}{z}_{N} {sinα}_{N} {cosβ}_{N} + \\ {y}_{N} {sinβ}_{N}\end{matrix} \\ \begin{matrix}{z}_{N} {cosα}_{N} {cosβ}_{N} + \\ {y}_{N} {sinβ}_{N}\end{matrix} \\ \begin{matrix}{y}_{N} {cosα}_{N} {cosβ}_{N} + \\ {x}_{N} {sinα}_{N} {cosβ}_{N}\end{matrix}\end{matrix} )$$

where x_{N} represents a longitudinal coordinate of the N-th thruster unit relative to the center of the wind turbine platform; y_{N} represents a lateral coordinate of the N-th thruster unit relative to the center of the wind turbine platform; z_{N} represents a vertical coordinate of the N-th thruster unit relative to the center of the wind turbine platform; α_{N} represents a horizontal angle of the N-th thruster unit relative to the center of the wind turbine platform; and β_{N} represents a vertical inclination angle of the N-th thruster unit relative to the center of the wind turbine platform.

T represents a thrust matrix for the thruster units, which can be expressed as follows:

$$T = [ \begin{matrix}{T}_{1} \\ {T}_{2} \\ ⋮ \\ {T}_{N}\end{matrix} ]$$

where T_{N} is a thrust generated by the N-th thruster unit.

The control method includes: distributing the required thrust for the thruster units based on the positions and directions of the thruster units, and combining the proportions of the thruster units according to their respective directions and positions, thereby satisfying requirements for total thrust magnitude and direction by using an optimization objective of minimizing total thrust and total power of the thruster units.

This application offers the following beneficial effects:

1. Combination of Mooring and Dynamic Positioning Systems: By integrating traditional mooring methods with a dynamic positioning system, the approach not only reduces the tension experienced by conventional mooring lines but also minimizes the maximum offset and tilt angle of the foundation of the wind turbine platform. Consequently, this configuration positively impacts the selection and lifespan of the mooring lines, dynamic cables, and wind turbine units.

2. Strategic Placement of Thruster Units: Thruster units are installed beneath the traditional semi-submersible platform foundation, with one set of thruster units positioned beneath each of the three pillars.

3. Precise Thrust Control: The method allows for the control of thruster units and the calculation of the necessary thrust loads to maintain the wind turbine platform within a specified movement range while meeting mooring tension requirements. Ultimately, this results in an accurate calculation of the power required by the thruster units.

By combining traditional mooring methods with a dynamic positioning system, the present disclosure effectively reduces the loads on the mooring lines while also decreasing the maximum offset and tilt angle of the platform foundation, benefiting the dynamic cables, wind turbine efficiency, and overall service life.

### BRIEF DESCRIPTION OF THE DRAWINGS

FIG. 1 shows an overall schematic structural diagram of a mooring system for a floating offshore wind turbine platform according to one embodiment of the present disclosure.

FIG. 2 shows a schematic structural diagram of a dynamic mooring system of a mooring system for a floating offshore wind turbine platform according to one embodiment of the present disclosure.

FIG. 3 shows a schematic structural diagram of a thruster unit of a mooring system for a floating offshore wind turbine platform according to one embodiment of the present disclosure.

FIG. 4 shows a schematic diagram of a mooring system for a floating offshore wind turbine platform according to one embodiment of the present disclosure.

FIG. 5 shows a schematic diagram of a mooring system for a floating offshore wind turbine platform according to one embodiment of the present disclosure.

FIG. 6 shows a schematic flow chart of a mooring system and a monitoring system for a floating offshore wind turbine platform according to one embodiment of the present disclosure.

### REFERENCE NUMERALS

1 Pillar
2 Buoy
3 Mooring cable
4 Thruster unit
5 Supporting drive shaft
6 Propeller
7 Rotating motor
8 Universal joint
9 Platform

### DETAILED DESCRIPTION

The following provides a more detailed explanation of the specific embodiments of the present disclosure in conjunction with the accompanying drawings. These embodiments are intended solely for illustrative purposes and do not limit the scope of this application.

In the description of the present disclosure, it is important to note that the terms “center,” “longitudinal,” “lateral,” “up,” “down,” “front,” “back,” “left,” “right,” “vertical,” “horizontal,” “top,” “bottom,” “inner,” “outer,” and other directional or positional relationships are based on the orientations or positional relationships illustrated in the accompanying drawings. These terms are used for the convenience of describing this application and simplifying the description, and they do not indicate or imply that the devices or components referred to must have a specific orientation or be constructed and operated in a particular manner. Therefore, these terms should not be construed as limitations on this application. In addition, the terms like “first” and “second” are used for descriptive purpose only, and are not to be construed as indicating or implying relative importance.

In the description of the present disclosure, it should be noted that unless explicitly stated otherwise, the terms “installed,” “connected,” and “coupled” should be understood in a broad sense, for example, there may be a fixed connection, a removable connection, or a connection in one piece; there may be a mechanical connection or an electrical connection; there may be a direct connection or an indirect connection through an intermediate medium, and there may be a connection within the two elements. For ordinary technicians in this field, the specific meanings of the above terms in this disclosure can be understood according to the specific circumstances.

Furthermore, in the description of the present disclosure, unless otherwise specified, the term “multiple” refers to two or more.

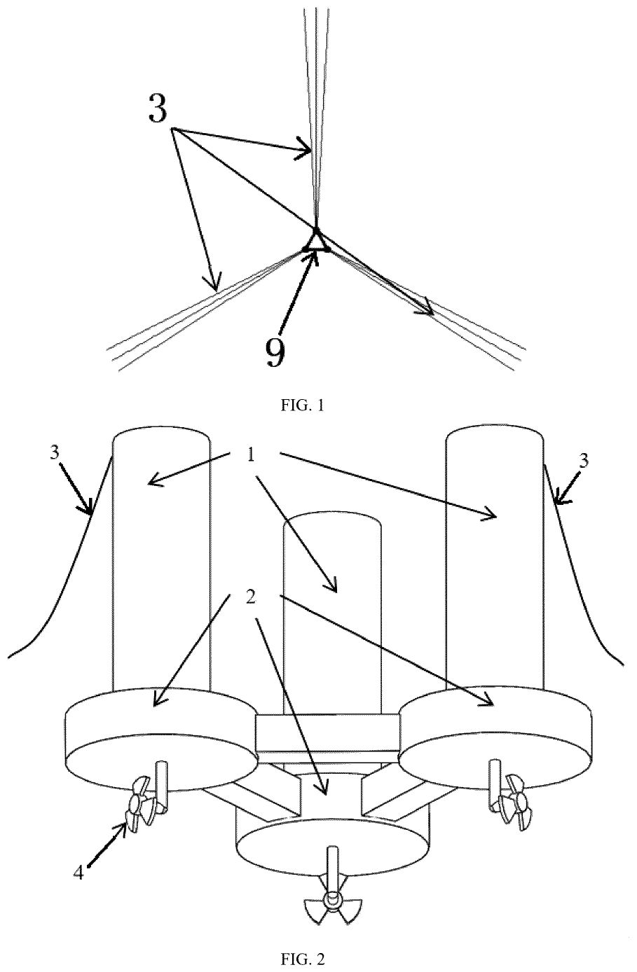

As shown in FIGS. 1-3, a mooring system for a floating offshore wind turbine platform includes a static mooring system and a dynamic mooring system.

As shown in FIG. 1, the static mooring system includes three mooring cable bundles. Each of the mooring cable bundles is connected to one of pillars 1 of the wind turbine platform, each of the mooring cable bundles includes 1 to 3 mooring cables 3 and has a catenary shape, and the center of the pillars 1 coincides with the center of the mooring cable bundles.

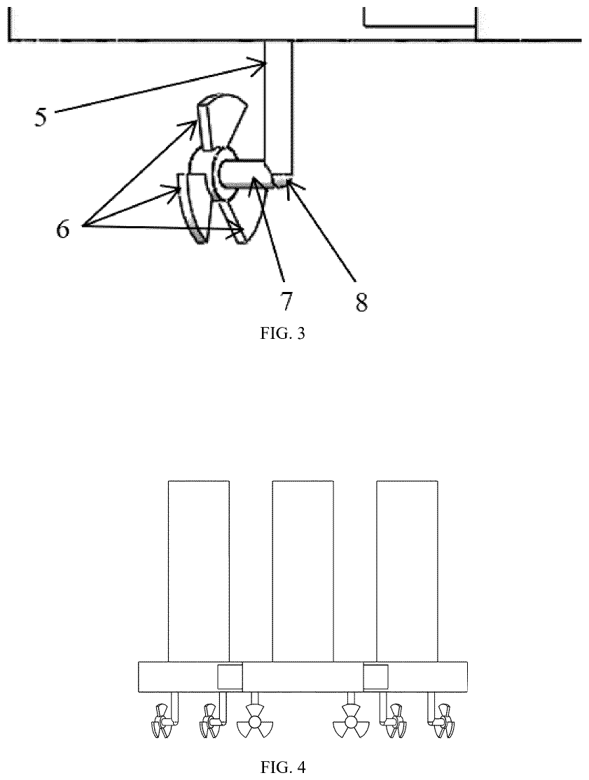

As shown in FIGS. 2-3, the dynamic mooring system includes power units, thruster units 4, and control units.

Each of the power units includes an engine, a generator set, a distribution panel, and cables.

Each of the thruster units 4 includes a supporting drive shaft 5, propellers 6, a rotating motor 7, and a universal joint 8.

The control unit includes a positioning system, a sensor, a computer system, a control interface, a control strategy module, and a power management module.

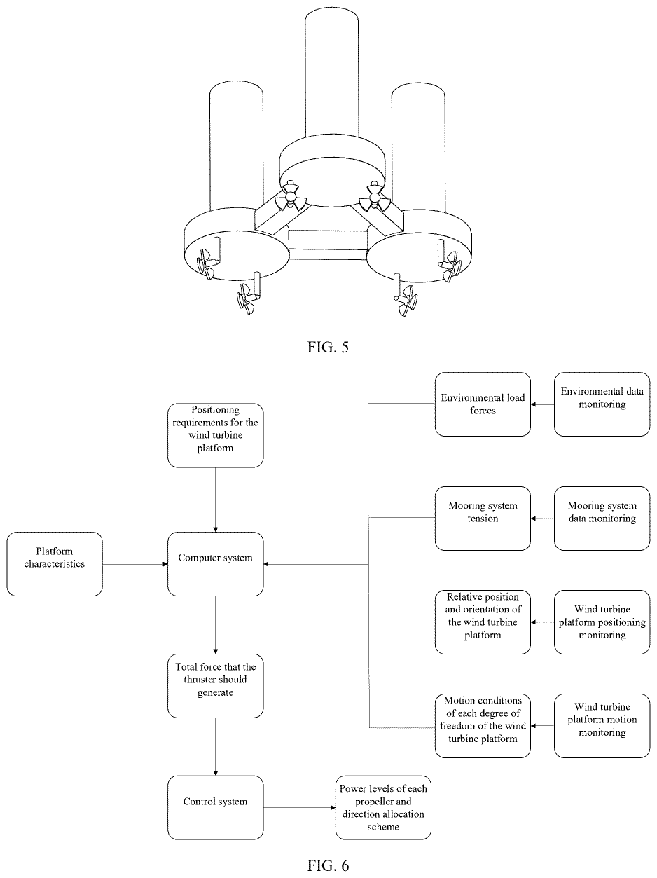

As shown in FIGS. 2, 4, and 5, a set of thruster units 4 is installed beneath each of the pillars 1 of the wind turbine platform 9. Each set of the thruster units includes 1 to 4 thruster units 4, and the specific configuration and quantity are determined by the actual design. Each of the thruster units 4 generates longitudinal, lateral, and vertical thrust and rotational torque, working in conjunction with the mooring system to maintain safe and stable positioning of the wind turbine platform within the target range.

Specifically, the pillars 1 of the wind turbine platform 9 are arranged in a circular array, and the center of the circular array coincides with the center of the wind turbine platform or the center of arrangement of all pillars.

Specifically, the mooring cable bundles are arranged in a circular array, and the center of the circular array coincides with the center of the wind turbine platform or the center of arrangement of all pillars.

Specifically, the angle between two adjacent mooring cable bundles is 120°.

In some embodiments, each set of the thruster units may include one thruster unit, and the thruster unit is installed directly beneath one of the pillars.

In some embodiments, each set of the thruster units may include two thruster units, and the two thruster units are symmetrically installed on two sides beneath one of the pillars.

In some embodiments, each set of the thruster units may include three thruster units. The three thruster units are uniformly distributed beneath one of the pillars in an equilateral triangle formation, and each of the thruster units maintains equal distance from the center axis of the one of the pillars.

In some embodiments, each group of thruster units may include four thruster units. The four thruster units are installed at the corners beneath one of the pillars, and each of the thruster units maintains equal distance from the center axis of the one of the pillars.

Specifically, each set of the thruster units has degrees of freedom for rotation of 360 degrees in the horizontal direction and 90 degrees in the vertical direction.

As shown in FIG. 6, a platform monitoring method for a mooring system of a floating offshore wind turbine platform involves the implementation of monitoring the wind turbine platform by the platform monitoring system. This system obtains real-time motion levels and mooring tension of the wind turbine platform. Based on the real-time motion state, the system calculates the required power for the thruster units according to the wind turbine platform's tilt and mooring tension requirements. During implementation, the platform monitoring system continuously monitors the wind turbine platform and provides feedback on its real-time motion levels and mooring tension, subsequently calculating the power needed for the thruster units.

As shown in FIG. 6, a platform monitoring system for a mooring system of a floating offshore wind turbine platform includes a positioning monitoring system and an environmental measurement system.

The positioning monitoring system includes a satellite positioning system, a laser positioning system, and an underwater ultra-short baseline acoustic positioning device. This system measures the deviations in direction and distance between the wind turbine platform and reference points to calculate the actual direction and position of the wind turbine platform.

The environmental measurement system includes a platform motion measurement system, an anemometer for wind speed and direction, a compass, a mooring system tension monitoring system, and an offshore hydrometeorological observation platform. Through these devices, the environmental measurement system can measure the motion parameters of the wind turbine platform in six degrees of freedom, tension values of the mooring system, wind speed and direction parameters at the wind turbine, and wave and current parameters of the surrounding environment. These data are used to estimate the external force loads acting on the wind turbine platform.

A platform monitoring method for a mooring system of a floating offshore wind power platform includes the following steps: In the first step, external environmental conditions such as wind, waves, and currents are read through the environmental measurement system to calculate the external environmental loads on the wind turbine platform. The real-time tension of the mooring system is obtained by reading from the positioning monitoring system. The relative position and direction of the wind turbine foundation platform are obtained by reading from a wind turbine platform positioning monitoring system, and the acceleration and velocity of motion in six degrees of freedom of the wind turbine platform are obtained by reading from the wind turbine platform motion monitoring system.

In the second step, the data obtained in the first step is analyzed and imported into a computer system. Based on the design positioning requirements of the wind turbine platform and the inherent characteristics of the wind turbine platform—such as weight, center, center of buoyancy, static water stiffness, and damping parameters—the required force to maintain the wind turbine platform's displacement and direction is calculated by the computer system, this force represents the resultant force that the entire thrust system should generate.

Specifically, a wind load F^{wd}(x) caused by aerodynamic loads on the wind turbine is assessed using the blade element momentum theory, as expressed in following equation:

$${F}^{wd} ( x ) = 0.5 {ρ C}_{T} {A}_{rotor} {U}_{10 min}^{2}$$

where ρ represents air density, C_{T} represents a thrust coefficient, Aᵣₒₜₒᵣ represents a swept area of the wind rotor, Aᵣₒₜₒᵣ=πR², R represents a radius of the wind rotor, and U_{10 min} represents a 10-minute average wind speed at hub height.

A wave load

$${\overline{{F}_{i}}}^{wa} ( x )$$

on the foundation of the wind turbine platform can be calculated using the measured wave spectrum S(ω), expressed as:

$${\overline{{F}_{i}}}^{wa} = {\int }_{0}^{∞} {C}_{i}^{wa} ( ω , β ) S ( ω ) d ω$$

where

$${\overline{{F}_{i}}}^{wa}$$

represents an average wave force numerator; β represents a wave direction relative to a longitudinal axis of the wind turbine platform;

$${C}_{i}^{wa} ( ω , β )$$

represents a wave drift coefficient relative to the wave direction; and S(ω) represents the wave spectrum.

An average wind load

$${\overline{{F}_{i}}}^{wi}$$

on the foundation of the wind turbine platform can be calculated using the measured wind speed, expressed as:

$${\overline{{F}_{i}}}^{wi} = {C}_{i}^{wi} ( β ) {\overline{V}}^{2}$$

where

$${C}_{i}^{wi}$$

represents a wind force coefficient for each direction of the foundation of the wind turbine platform; β represents a wind direction relative to a longitudinal axis of the wind turbine platform; and V̅ represents average wind speed.

A current load

$${F}_{i}^{cu}$$

on the foundation of the wind turbine platform can be calculated based on the measured flow velocity, expressed as:

$${F}_{i}^{cu} = {C}_{L , i}^{cu} ( β ) {V}_{rel} + {C}_{Q , i}^{cu} ( β ) {V}_{rel}^{2}$$

$${V}_{rel} = \sqrt{{( {v}_{1}^{cu} - {v}_{1} )}^{2} + {( {v}_{2}^{cu} - {v}_{2} )}^{2}}$$

where

$${C}_{L , i}^{cu}$$

represents a primary flow force coefficient for each direction of the foundation of the wind turbine platform;

$${C}_{Q , i}^{cu}$$

represents a secondary now force coefficient for each direction of the foundation of the wind turbine platform;

$${v}_{1}^{cu} , {v}_{2}^{cu}$$

represent horizontal components of the flow velocity; v₁, v₂ represents longitudinal and lateral velocities of the wind turbine platform; and Vᵣₑₗ represents an intermediate value of

$${v}_{1}^{cu} , {v}_{2}^{cu} ,$$

v₁, v₂ and is used to calculate the value of the current load

$${F}_{i}^{cu} .$$

A static equilibrium calculation for the wind turbine platform can be expressed as follows:

$${F}^{mo} ( x ) + {F}^{hs} ( x ) + {F}^{th} ( x ) + {F}^{cu} ( x ) + {F}^{wi} ( x ) + {F}^{wd} ( x ) + {F}^{wa} ( x ) = 0$$

where F^{mo}(x) represents the mooring tension; F^{hs}(x) represents a static water force on the foundation of the wind turbine platform; F^{th}(x) represents a total force of thruster units; F^{cu}(x) represents a current load on the foundation of the wind turbine platform; F^{wi}(x) represents a wind load on the foundation of the wind turbine platform; F^{wd}(x) represents a wind load on the wind turbine; and F^{wa}(x) wave represents a wave load on the foundation of the wind turbine platform.

Specifically, as shown in FIG. 6, the method includes a control method for sets of thruster units, designed to control at least two sets of thruster units.

The thrust can be controlled by real-time monitoring of the motion variables of the wind turbine platform, with the calculation expressed as follows:

$${F}^{th} ( x ) = - {G}_{P} Δ x - {G}_{V} ν + {F}^{0}$$

where G_{P} represents a displacement coefficient matrix; G_{V} represents a velocity coefficient matrix; Δx represents a displacement matrix of the wind turbine platform; v represents a velocity matrix of the wind turbine platform; and F⁰ represents a thrust constant.

The resultant thrust force is composed of the thrust generated by each of the thruster units, with the calculation expressed as follows:

$${F}^{th} ( x ) = AT$$

where A is the thruster unit matrix, comprising the positions and orientations of each thruster unit, expressed as follows:

$$A = [ \begin{matrix}cos {α}_{1} cos {β}_{1} & cos {α}_{2} cos {β}_{2} & ⋯ & cos {α}_{N} cos {β}_{N} \\ sin {α}_{1} cos {β}_{1} & sin {α}_{2} cos {β}_{2} & ⋯ & sin {α}_{N} cos {β}_{N} \\ sin {β}_{1} & sin {β}_{2} & ⋯ & sin {β}_{N} \\ {z}_{1} sin {α}_{1} cos {β}_{1} + {y}_{1} sin {β}_{1} & {z}_{2} sin {α}_{2} cos {β}_{2} + {y}_{2} sin {β}_{2} & ⋯ & {z}_{N} sin {α}_{N} cos {β}_{N} + {y}_{N} sin {β}_{N} \\ {z}_{1} cos {α}_{1} cos {β}_{1} + {x}_{1} sin {β}_{1} & {z}_{2} cos {α}_{2} cos {β}_{2} + {x}_{2} sin {β}_{2} & ⋯ & {z}_{N} cos {α}_{N} cos {β}_{N} + {x}_{N} sin {β}_{N} \\ {y}_{1} cos {α}_{1} cos {β}_{1} + {x}_{1} sin {α}_{1} cos {β}_{1} & {y}_{2} cos {α}_{2} cos {β}_{2} + {x}_{2} sin {α}_{2} cos {β}_{2} & ⋯ & {y}_{N} cos {α}_{N} cos {β}_{N} + {x}_{N} sin {α}_{N} cos {β}_{N}\end{matrix} ]$$

where x_{N} represents the longitudinal coordinate of the N-th thruster unit relative to the center of the wind turbine platform; y_{N} represents the lateral coordinate of the N-th thruster unit relative to the center of the wind turbine platform; z_{N} represents the vertical coordinate of the N-th thruster unit relative to the center of the wind turbine platform; an represents the horizontal angle of the N-th thruster unit relative to the center of the wind turbine platform; and β_{N} represents the vertical inclination angle of the N-th thruster unit relative to the center of the wind turbine platform.

T represents the thrust matrix for the thruster units, which can be expressed as follows:

$$T = [ \begin{matrix}{T}_{1} \\ {T}_{2} \\ ⋮ \\ {T}_{N}\end{matrix} ]$$

where T_{N} is the thrust generated by the N-th thruster unit.

Based on the positions and orientations of the thruster units, the required thrust for each thruster unit is allocated. The contributions of each thruster unit are combined to minimize the total thrust and overall power requirements while satisfying the necessary magnitude and direction of the total thrust.

Specifically, thrust can be controlled by real-time monitoring of motion variables of the wind turbine platform, as expressed in the following equation:

$${F}^{th} ( x ) = - {G}_{P} Δ x - {G}_{V} ν + {F}^{0}$$

Considering an extreme condition with significant wave height Hs=14.1 m, Tp=17.8 s, wind speed=38.2 m/s, and current speed Vc=1.2 m/s, the total environmental load on the wind turbine platform is calculated to be 5000 kN. Three sets of thrusters, each rated at 100 tons, are arranged directly beneath each of the pillars of the wind turbine platform, respectively. The displacement coefficient of these thrusters is 20 kN/m, and the velocity coefficient is 1200 kN/(m/s). The wind turbine platform experiences a longitudinal displacement of 22.6 m and a lateral displacement of 2.7 m. The longitudinal velocity of the wind turbine platform is 0.72 m/s and the lateral velocity is 0.06 m/s. The thrust constant is 1500 kN. Through calculations, the total thrust provided by the thrusters is determined to be 2500 kN, this thrust is capable of counteracting 50% of the total environmental load acting on the wind turbine platform, significantly reducing the load borne by the mooring cables. Therefore, in scenarios where floating wind turbines experience substantial wind, wave, and current loads, the integration of thrusters with the mooring cables allows the existing mooring system to meet the demands of high-load resistance, thereby enhancing the overall safety of the mooring system.

The above-mentioned description represents a preferred embodiment of the present disclosure. It should be noted that for those skilled in the art, several modifications and substitutions can be made without departing from the technical principles of this application. Such modifications and substitutions should also be considered within the scope of the present application's protection.

1. (canceled)

2. (canceled)

3. (canceled)

4. (canceled)

5. (canceled)

6. (canceled)

7. A platform monitoring method for a mooring system of a floating offshore wind turbine platform, comprising the following steps:
step 1: reading external environmental conditions through an environmental measurement system to calculate external environmental loads acting on the wind turbine platform, wherein the external environmental conditions comprise wind, waves, and currents; reading real-time tension of the mooring system through a positioning monitoring system; reading relative position and direction of the wind turbine platform through a wind turbine platform positioning monitoring system; and reading acceleration and velocity of motion in six degrees of freedom of the wind turbine platform through a wind turbine platform motion monitoring system; and
step 2: analyzing data obtained from step 1 and importing the analyzed data into a computer system; calculating required acting force to maintain the wind turbine platform's displacement and direction based on design positioning requirements of the wind turbine platform and inherent characteristics of the wind turbine platform, wherein the inherent characteristics comprises weight, center, center of buoyancy, static stiffness, and damping parameters, wherein the acting force represents a resultant force that entire thrust system should generate;
wherein the platform monitoring method further comprises a control method for thruster units, applicable to at least two sets of the thruster units, comprising the following steps:
distributing a required thrust for the thruster units based on their positions and directions; and
combining proportions of the thruster units based on their respective directions and positions, thereby satisfying requirements for total thrust magnitude and direction by using an optimization objective of minimizing a total thrust and total power of the thruster units.

8. The platform monitoring method for the mooring system of the floating offshore wind turbine platform according to claim 7, wherein a wind load F^{wd}(x) on a wind turbine of the wind turbine platform is assessed using a blade element momentum theory, with a calculation formula as follows:
$${F}^{wd} ( x ) = 0.5 ρ {C}_{T} {A}_{rotor} {U}_{10 min}^{2}$$
wherein ρ represents air density, C_{T} represents a thrust coefficient, Aᵣₒₜₒᵣ represents a swept area of a wind rotor, Aᵣₒₜₒᵣ=πR², R represents a radius of the wind rotor, and U_{10 min} represents a 10-minute average wind speed at hub height;
wherein a wave load
$${\overline{{F}_{i}}}^{wa} ( x )$$
on a foundation of the wind turbine platform is calculated using a measured wave spectrum S(ω), expressed as:
$${\overline{{F}_{i}}}^{wa} = 2 {\int }_{0}^{∞} {C}_{i}^{wa} ( ω , β ) S ( ω ) dω$$
wherein
$${\overline{{F}_{i}}}^{w a}$$
represents an average wave force numerator; β represents a wave direction relative to a longitudinal axis of the wind turbine platform;
$${C}_{i}^{wa} ( ω , β )$$
represents a wave unit coefficient relative to the wave direction; and S(ω) represents a wave spectrum;
wherein an average wind load
$${\overline{F}}_{i}^{w i}$$
on the foundation of the wind turbine platform is calculated using a measured wind speed, expressed as:
$${\overline{F}}_{i}^{w i} = {C}_{i}^{wi} ( β ) {\overline{V}}^{2}$$
wherein
$${C}_{i}^{w i}$$
represents a wind force coefficient for each direction of the foundation of the wind turbine platform; β represents a wind direction relative to a longitudinal axis of the wind turbine platform; and V̅ is an average wind speed;
wherein a current load
$${F}_{i}^{c u}$$
on the foundation of the wind turbine platform is calculated based on a measured flow velocity, expressed as:
$${F}_{i}^{c u} = {C}_{L , i}^{c u} ( β ) {V}_{r e l} + {C}_{Q , i}^{c u} ( β ) {V}_{r e l}^{2}$$
$${V}_{r e l} = \sqrt{{( {v}_{1}^{c u} - {v}_{1} )}^{2} + {( {v}_{2}^{c u} - {v}_{2} )}^{2}}$$
wherein
$${C}_{L , i}^{c u}$$
represents a primary flow force coefficient for each direction of the foundation of the wind turbine platform;
$${C}_{Q , i}^{c u}$$
represents a secondary flow force coefficient for each direction of the foundation of the wind turbine platform;
$${v}_{1}^{c u} , {v}_{2}^{c u}$$
represent horizontal components of a flow velocity; and v₁, v₂ represents longitudinal and lateral velocities of the wind turbine platform;
wherein a static equilibrium calculation for the wind turbine platform is expressed as follows:
$${F}^{m o} ( x ) + {F}^{h s} ( x ) + {F}^{th} ( x ) + {F}^{c u} ( x ) + {F}^{wi} ( x ) + {F}^{w d} ( x ) + {F}^{w a} ( x ) = 0$$
wherein F^{mo}(x) represents a mooring tension; F^{hs}(x) represents a static water force on the foundation of the wind turbine platform; F^{th}(x) represents a total force of thruster units; F^{cu}(x) is a current load on the foundation of the wind turbine platform; F^{wi}(x) represents a wind load on the foundation of the wind turbine platform; F^{wd}(x) represents a wind load on the wind turbine; and F^{wa}(x) wave represents a wave load on the foundation of the wind turbine platform.

9. (canceled)

10. The platform monitoring method for the mooring system of the floating offshore wind turbine platform according to claim 7, wherein the thrust is controlled by real-time monitoring of motion variables of the wind turbine platform, and a calculation formula of the thrust is as follows:
$${F}^{th} ( x ) = - {G}_{P} Δ x - {G}_{V} ν + {F}^{0}$$
wherein G_{P} represents a displacement coefficient matrix; G_{V} represents a velocity coefficient matrix; Δx represents a displacement matrix of the wind turbine platform; v represents a velocity matrix of the wind turbine platform; and F⁰ represents a thrust constant;
wherein a resultant thrust force is composed of thrust generated by each of the thruster units, with a calculation expressed as follows:
$${F}^{th} ( x ) = A T$$
wherein A is a thruster unit matrix, comprising positions and orientations of each thruster unit, expressed as follows:
$$A = [ \begin{matrix}cos {α}_{1} cos {β}_{1} & cos {α}_{2} cos {β}_{2} & … & cos {α}_{N} cos {β}_{N} \\ sin {α}_{1} cos {β}_{1} & sin {α}_{2} cos {β}_{2} & … & sin {α}_{N} cos {β}_{N} \\ sin {β}_{1} & sin {β}_{2} & … & sin {β}_{N} \\ \begin{matrix}{z}_{1} sin {α}_{1} cos {β}_{1} + \\ {y}_{1} sin {β}_{1}\end{matrix} & \begin{matrix}{z}_{2} sin {α}_{2} cos {β}_{2} + \\ {y}_{2} sin {β}_{2}\end{matrix} & … & \begin{matrix}{z}_{N} sin {α}_{N} cos {β}_{N} + \\ {y}_{N} sin {β}_{N}\end{matrix} \\ \begin{matrix}{z}_{1} cos {α}_{1} cos {β}_{1} + \\ {x}_{1} sin {β}_{1}\end{matrix} & \begin{matrix}{z}_{2} cos {α}_{2} cos {β}_{2} + \\ {x}_{2} sin {β}_{2}\end{matrix} & … & \begin{matrix}{z}_{N} cos {α}_{N} cos {β}_{N} + \\ {x}_{N} sin {β}_{N}\end{matrix} \\ \begin{matrix}{y}_{1} cos {α}_{1} cos {β}_{1} + \\ {x}_{1} sin {α}_{1} cos {β}_{1}\end{matrix} & \begin{matrix}{y}_{2} cos {α}_{1} cos {β}_{2} + \\ {x}_{2} sin {α}_{2} cos {β}_{2}\end{matrix} & … & \begin{matrix}{y}_{N} cos {α}_{N} cos {β}_{N} + \\ {x}_{N} sin {α}_{N} cos {β}_{N}\end{matrix}\end{matrix} ]$$
wherein x_{N} represents a longitudinal coordinate of an N-th thruster unit relative to the center of the wind turbine platform; y_{N} represents a lateral coordinate of the N-th thruster unit relative to the center of the wind turbine platform; z_{N} represents a vertical coordinate of the N-th thruster unit relative to center of the wind turbine platform; α_{N} represents a horizontal angle of the N-th thruster unit relative to center of the wind turbine platform; and β_{N} represents a vertical inclination angle of the N-th thruster unit relative to center of the wind turbine platform;
T represents a thrust matrix for the thruster units, wherein the thrust matrix is expressed as follows:
$$T = [ \begin{matrix}{T}_{1} \\ {T}_{2} \\ ⋮ \\ {T}_{N}\end{matrix} ]$$
wherein T_{N} is a thrust generated by the N-th thruster unit.

11. The platform monitoring method for the mooring system of the floating offshore wind turbine platform according to claim 7, wherein the mooring system for the floating offshore wind turbine platform comprises a static mooring system and a dynamic mooring system;
wherein the static mooring system comprises three mooring cable bundles, wherein each of the mooring cable bundles is connected to one of pillars of the wind turbine platform; each of the mooring cable bundles comprises 1 to 3 mooring cables and is configured in a catenary shape; wherein the center of the pillars coincides with the center of the mooring cable bundles;
wherein the dynamic mooring system comprises power units, the thruster units, and control units;
wherein each of the power units comprises an engine, a generator set, a distribution panel, and cables;
wherein each of the thruster units comprises a supporting drive shaft, propellers, a rotating motor, and a universal joint;
wherein each of the control units comprises a positioning system, a sensor, a computer system, a control interface, a control strategy module, and a power management module; and
wherein a set of the thruster units is installed below each of the pillars of the wind turbine platform, each set of the thruster units comprising 1 to 4 thruster units.

12. The platform monitoring method for the mooring system of the floating offshore wind turbine platform according to claim 11, wherein the pillars of the wind turbine platform are arranged in a circular array, and the center of the circular array of the pillars coincides with the center of the wind turbine platform or the center of arrangement of all pillars; wherein the mooring cable bundles are arranged in a circular array, and the center of the circular array of the mooring cable bundles coincides with the center of the wind turbine platform or the center of arrangement of all pillars.

13. The platform monitoring method for the mooring system of the floating offshore wind turbine platform according to claim 11, wherein each set of the thruster units has degrees of freedom for rotation of 360 degrees in a horizontal direction and 90 degrees in a vertical direction.

14. The platform monitoring method for the mooring system of the floating offshore wind turbine platform according to claim 11, wherein an included angle between each two adjacent ones of the mooring cable bundles is 120 degrees.

15. The platform monitoring method for the mooring system of the floating offshore wind turbine platform according to claim 11, wherein each set of the thruster units comprises one thruster unit, and the thruster unit is installed directly below one of the pillars; or
wherein each set of the thruster units comprises two thruster units, and the two thruster units are symmetrically installed on two sides below one of the pillars; or
wherein each set of the thruster units comprises three thruster units, the three thruster units are uniformly distributed below one of the pillars in an equilateral triangle, and each of the thruster units maintains equal distance from the center axis of the one of the pillars; or
wherein each set of the thruster units comprises four thruster units, the four thruster units are installed at four corners below one of the pillars, and each of the thruster units maintains equal distance from the center axis of the one of the pillars.

16. The platform monitoring method for the mooring system of the floating offshore wind turbine platform according to claim 7, further comprising:
providing a platform monitoring system for the mooring system of the floating offshore wind turbine platform, wherein the platform monitoring system comprises:
a positioning monitoring system, comprising a satellite positioning system, a laser positioning system, and an underwater ultra-short baseline acoustic positioning device, wherein the positioning monitoring system calculates an actual direction and position of the wind turbine platform by measuring deviations in direction and distance between the wind turbine platform and reference points; and
an environmental measurement system, comprising a platform motion measurement system, an anemometer for wind speed and direction, an electrical compass, a mooring system tension monitoring system, and an offshore hydrometeorological observation platform; wherein the environmental measurement system is configured to measure motion parameters of the wind turbine platform in six degrees of freedom, tension values of the mooring system, wind speed and direction parameters at a wind turbine of the wind turbine platform, and wave and current parameters of environment in which the wind turbine platform is located, thereby estimating external force loads acting on the wind turbine platform.
